(19) United States
(12) Patent Application Publication
(10) Pub. No.: US 2021/0305937 A1
(43) Pub. Date: Sep. 30, 2021

(54) DEVICE AND METHOD FOR DETERMINING WHETHER POWER GENERATION SYSTEM IS ABNORMAL

(71) Applicant: Dong Sun KIM, Seoul (KR)

(72) Inventor: Dong Sun KIM, Seoul (KR)

(21) Appl. No.: 17/264,872

(22) PCT Filed: Jul. 30, 2019
(86) PCT No.: PCT/KR2019/009465

§ 371 Date: Feb. 1, 2021

(30) Foreign Application Priority Data
Aug. 1, 2018 (KR) 10-2018-0089999

(51) Int. Cl. H02S 50/10; H02S 20/23; G08C 17/02; G06N 20/00; H02S 40/30

(52) U.S. Cl. CPC H02S 50/10; H02S 20/23; H02S 40/30; G06N 20/00; G08C 17/02

(57) ABSTRACT

The present invention relates to a device for determining whether a power generation system is abnormal. More specifically, the device may comprise: a communication unit for receiving power generation data from at least one power generation system; a storage unit for storing the received data; and a processor for selecting, from the collected data, power generation systems in a similar region, and determining whether a specific power generation system is abnormal by comparing the power generation times and power generation amounts of the power generation systems in the similar region.

### TECHNICAL FIELD

The present disclosure relates to a device for determining whether a power generation system is abnormal and, more particularly, to a method and device for determining whether a power generation system is abnormal while performing integrated monitoring of a system.

### BACKGROUND ART

As a method to reduce recent domestic nuclear power plants and fossil fuels, solar power generation devices in the field of renewable energy are being spread. Also, research on power generation devices, materials and parts for the solar industry that can be obtained from nature in preparation for the depletion of fuel is increasing worldwide.

The supply of such solar power generation systems is expanding not only to individual large-scale power plants but also to individual households, and development of a monitoring system for managing them is required.

### DISCLOSURE OF INVENTION

### Technical Solutions

According to an aspect, there is provided a method of determining whether an abnormality is present in a renewable energy generation system performed at least temporarily by a computer at predetermined time intervals, the method including receiving, by a communicator, power generation data from a plurality of power generation systems, storing, by a storage, the received data, selecting, by a processor, power generation systems of similar regions from the data collected, converting, by the processor, power generation amounts of the selected power generation systems of the similar regions into power generation time indices, and determining, by the processor, whether an abnormality is present in a predetermined power generation system by comparing the power generation time indices.

Each of the power generation indices may be an index calculated by dividing a power generation amount obtained for a predetermined period of time in a power generation system by a power generation capacity.

The selecting of the power generation systems of the similar regions may use at least one of selecting a power generation system within a predetermined distance from a certain position, selecting based on a classification in an administrative area, selecting based on an installation environment factor, and selecting based on a climate factor.

The determining of whether the abnormality is present in the predetermined power generation system may include calculating an average of power generation time indices of power generation systems of similar regions, determining whether a difference value between a power generation time index of each of the power generation systems and the average of the power generation indices exceeds a predetermined range, and determining that an abnormality is present when the difference value exceeds the range.

The determining of whether the abnormality is present in the predetermined power generation system may include comparing the power generation time indices of the power generation systems of the similar regions, and determining that an abnormality is present when a difference value calculated through the comparing exceeds a predetermined range.

The method may further include performing, by a machine learning unit, machine learning based on the data and whether the abnormality is present, and redetermining, by the machine learning unit, whether an abnormality is present in the power generation system.

When a predetermined power generation system is determined to be abnormal, the method may further include redetermining whether an abnormality is present in a power generation system using at least one of previous power generation amount data, climate, a sensor defect, and a maintenance history of the predetermined power generation system.

According to another aspect, there is also provided a device for determining whether an abnormality is present in a power generation system, the device including a communicator configured to receive power generation data from at least one power generation system, a storage configured to store the received data, and a processor configured to select power generation systems of similar regions from the data collected and determine whether an abnormality is present in a predetermined power generation system by comparing power generation time indices of the power generation systems of similar regions.

Each of the power generation indices may be an index calculated by dividing a power generation amount obtained for a predetermined period of time in a power generation system by a power generation capacity.

The processor may be configured to select the power generation systems of the similar regions using at least one of a method of selecting a power generation system within a predetermined distance from a certain position, a method of selecting based on a classification in an administrative area, a method of selecting based on an installation environment factor, and a method of selecting based on a climate factor.

The processor may be configured to calculate an average of power generation time indices of power generation systems of similar regions, determine whether a difference value between a power generation time index of each of the power generation systems and the average of the power generation indices exceeds a predetermined range, and when the difference value exceeds the range, determine that an abnormality is present.

The processor may be configured to compare the power generation time indices of the power generation systems of the similar regions, calculate a difference value through the comparing, and when a difference value calculated through the comparing exceeds a predetermined range, determine that an abnormality is present.

The device may further include a machine learning unit configured to perform machine learning based on the data and whether the abnormality is present and redetermine whether an abnormality is present in the power generation system.

When a predetermined power generation system is determined to be abnormal, whether an abnormality is present in a power generation system may be redetermined using at least one of previous power generation amount data, climate, a sensor defect, and a maintenance history of the predetermined power generation system.

There is also provided a computer-readable recording medium including a program for performing the method of determining whether the abnormality is present in the power generation system.

### BRIEF DESCRIPTION OF DRAWINGS

FIG. 1 illustrates solar modules installed in similar houses according to an example embodiment.

FIG. 2 illustrates a configuration of an integrated monitoring system for managing power generation systems in a plurality of regions according to an example embodiment.

FIG. 3 illustrates a power generation system of a specific region according to an example embodiment.

FIG. 4 is a flowchart for determining whether an abnormality is present in a predetermined power generation system according to an example embodiment.

FIG. 5 illustrates an integrated monitoring system monitoring a specific region according to an example embodiment.

FIG. 6 illustrates a management configuration of an integrated monitoring system according to an example embodiment.

FIG. 7 illustrates a real-time monitoring result of an integrated monitoring system according to an example embodiment.

### BEST MODE FOR CARRYING OUT THE INVENTION

Hereinafter, example embodiments will be described in detail with reference to the accompanying drawings. It should be understood, however, that there is no intent to limit this disclosure to the particular example embodiments disclosed. Like numbers refer to like elements throughout.

Terms used in the present disclosure have been selected as widely used general terms as possible in consideration of the functions in the present disclosure, but this may vary according to the intention or precedent of the person skilled in the art, the emergence of new technologies and the like.

In addition, in certain cases, there is also a term arbitrarily selected by the applicant, in which case the meaning will be described in detail in the description of the invention. Therefore, the terms used in the present disclosure should be defined based on the meanings of the terms and the contents throughout the present disclosure, rather than the names of the simple terms.

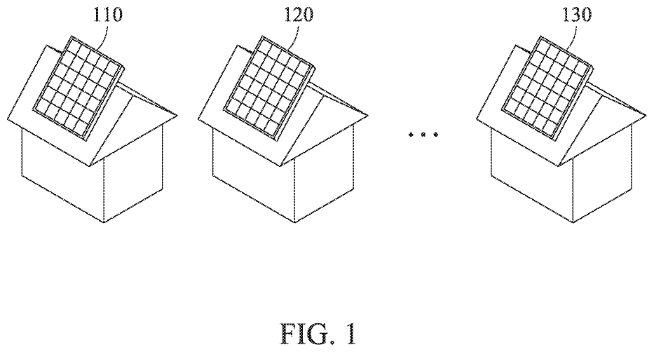

FIG. 1 illustrates solar modules installed in similar houses according to an example embodiment.

An integrated monitoring system according to an example embodiment may monitor power generation systems installed in a plurality of regions. The power generation system may be a power generation system using renewable energy and may be, for example, a solar energy generation system but not be limited thereto. FIG. 1 illustrates houses 110, 120, and 130 with solar power systems installed.

Due to a nature of solar power, an amount of power generation varies depending on climate, topography, an azimuth angle, and a shadow interference of an installation area, so maintenance management after initial installation is important. Maintenance and management of a typical solar power generation system may be performed through notification and visual inspection performed in a facility system.

For example, the maintenance and management may depend on a failure notification of an inverter connected to a solar power module and notifications of various sensors attached to the solar power generation system. However, there are many factors affecting the amount of power generation in practice. Specifically, if there is a foreign substance (e.g., mop, leaf, etc.) on the solar power module, the notification may not occur, but the amount of power generation is affected.

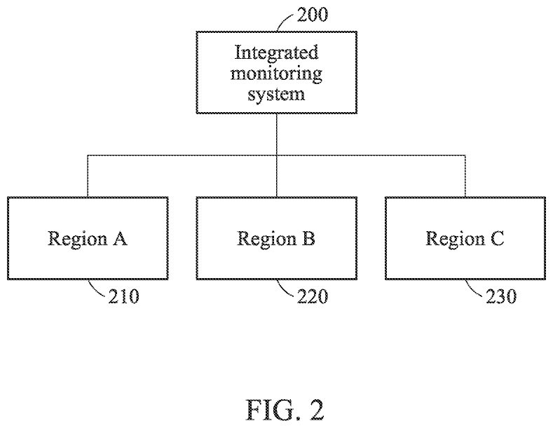

FIG. 2 illustrates a configuration of an integrated monitoring system for managing power generation systems in a plurality of regions according to an example embodiment.

An integrated monitoring system 200 may monitor power generation systems in a plurality of regions. For example, a power generation system of a region A 210, a power generation system of a region B 220, and a power generation system of a region C 230 may be monitored simultaneously.

The region A 210, the region B 220, and the region C 230 may be regions having different geographic characteristics, but in some cases may be regions having similar geographic characteristics. Three regions are described as an example, but the number of regions is not limited thereto. Depending on an example, monitoring of two or more regions is also possible.

Specifically, the region A 210 and the region B 220 are adjacent regions and may have similar meteorological and geographic environments. The region C 230 is a region far from the region A 210 and the region B 220. The region A 210, the region B 220, and the region C 230 may have different environmental factors.

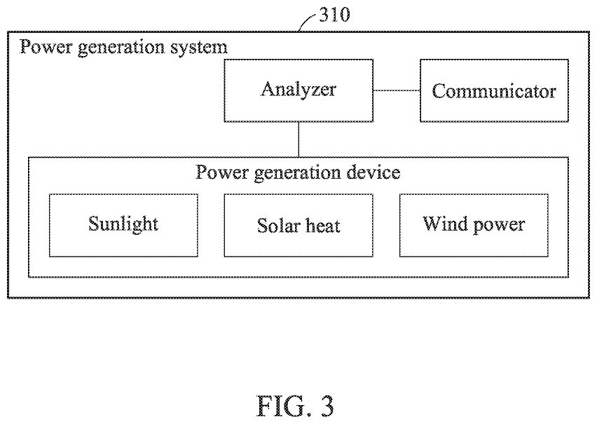

FIG. 3 illustrates a power generation system of a specific region according to an example embodiment. A power generation system 310 using renewable energy may include a power generation device, an analyzer, and a communicator.

For example, the power generation device of the power generation system 310 using the renewable energy may include, but not be limited to, solar energy generation, solar heat generation, and wind energy generation. In some cases, a method of using other types of renewable energy sources is possible.

Specifically, the power generation device may include at least one power generation device among a solar energy generation device, a solar heat energy generation device, and a geothermal energy generation device. For example, when the power generation device is the solar energy generation device, the power generation device may include a solar panel to acquire energy from sunlight, thereby generating power.

The analyzer may analyze power generation data generated from the power generation device. For example, the analyzer may analyze information on an amount of power generation, a power generation time, an amount of time for power generation obtained when the solar energy generation device is used. Further, it is also possible to analyze information on weekly power generation by calculating a total amount of daily power generation.

The communicator may transmit data generated in the analyzer to an integrated monitoring system. That is, the communicator may transmit data on the amount of power generation that is analyzed by the analyzer to the integrated monitoring system, so that the integrated monitoring system comprehensively manages a plurality of power generation systems.

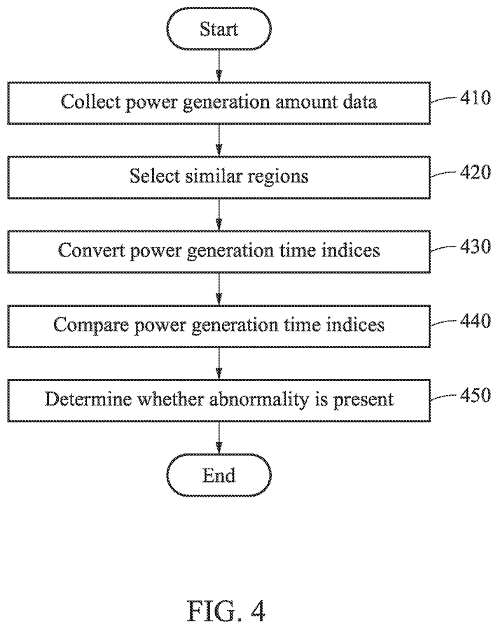

FIG. 4 is a flowchart for determining whether an abnormality is present in a predetermined power generation system according to an example embodiment. A method of determining whether an abnormality is present in a predetermined power generation system may include operation 410 of collecting power generation amount data, operation 420 of selecting similar regions, operation 430 of converting power generation time indices, operation 440 of comparing the power generation time indices, and operation 450 of determining whether an abnormality is present.

Specifically, operation 410 of collecting power generation amount data is an operation of collecting power generation amount data from a plurality of power generation systems. The plurality of power generation systems indicates that the power generation system of FIG. 3 exists in plural. Accordingly, the plurality of power generation systems may be power generation systems using renewable energy and, for example, may be a power generation system using energy such as solar power, solar heat, wind power, geothermal heat, and the like but not be limited thereto.

Power generation amount data may be collected from the plurality of power generation systems. As the power generation amount data, in addition to an amount of power generation, all information on a power generation time and an amount of time for power generation may be collected. In addition, various information associated with the amount of power generation such as a climate environment, a geographical environment, and a geographical location of the power generation system may be further collected. According to another example embodiment, information associated with a power generation system may be power generation system installation information and include, for example, an installation date, a module angle, a module azimuth angle, an inverter type of the power generation system.

Operation 420 of selecting similar regions is an operation of selecting similar regions based on the power generation amount data collected from the plurality of power generation systems. A similar region does not simply mean a spatially adjacent area, and may refer to an area having a similar power generation amount or power generation time of a power generation system.

Specifically, in a case of selecting based on a geographical location of a power generation system, a range within a predetermined radius from a specific location may be determined as a similar region. Alternatively, a method of selecting a region having a similar geographical environment to a predetermined power generation system as a similar region may also be possible. For example, in a location where a power generation system is installed, a region with a high mountain range in the south may be selected as a similar area. Also, a region in which a power generation system is installed on a roof of a building with five floors or more may be selected as a similar region.

In addition to the method of selecting the similar region based on the geographical environment, a method of selecting a similar region based on the climate environment may also be possible. For example, a region with at least ten hours of sunlight per day may be selected as a similar region. Also, a power generation system with a daily power generation amount of 10 kilowatts (kWh) or more may be selected as a similar region.

The aforementioned similar region selecting methods are merely provided as examples, and it is possible to select a similar region through various applications.

Operation 430 of converting a power generation time index is an operation of converting power generation amounts of the power generation systems into power generation time indices. Specifically, the power generation time index may be calculated by dividing a power generation amount for a predetermined period of time in a power generation system by a power generation capacity. For example, when calculating the power generation time index of one day, if the power generation amount for 24 hours is 400 kWh and the power generation capacity is 500 kW, the power generation time index may be 0.8. In some cases, the power generation time index may be calculated based on a power generation amount for a week or a month.

Operation 440 of comparing the power generation time index may be an operation of comparing amounts of power generation time of power generation systems in the similar regions selected. The power generation time index may be an index calculated in operation 430 of converting a power generation time index and may be associated with a power generation amount.

In operation 440 of comparing the power generation time index, power generation time indices of the power generation systems in the similar regions may be compared. Power generation time indices of a first power generation system and a second power generation system may be compared to determine whether an abnormality is present in operation 450. It is also possible to compare not only two power generation systems but also a larger number of power generation systems, and possible to determine which system has a larger or smaller power generation time index.

In operation 440 of comparing the power generation time index, power generation time indices corresponding to daily power generation amounts may be compared. In some cases, comparisons between regional power generation time indices, seasonal power generation time indices, power generation time indices by year, weekly power generation time indices, monthly power generation time indices, and power generation time indices for a period of time designated by a user may be possible. In addition, an average power generation time index of the power generation systems of the similar regions may be calculated so that the calculated average power generation time index is compared to a power generation time index of a predetermined power generation system.

Finally, in operation 450 of determining whether an abnormality is present, whether an abnormality is present may be determined using the power generation time index. Specifically, if different power generation time indices are obtained from solar power generation systems in similar regions having the same power generation time, it may be determined that there is an abnormality.

For example, the solar power generation may be most affected by ambient solar radiation, but not be limited thereto. Based on systems having the same power generation capacity, surrounding power generation systems may generate a predetermined amount of power. In this case, when a power generation amount of a specific power generation system radically decreases, it may be determined that an abnormality has occurred in a solar module (or panel). The abnormality may be, for example, a problem such as a foreign material that blocks sunlight entering the solar module or a problem that a light tracking function of a module is not properly performed.

However, it is merely an example, and there may be other problems. When the amount of power generation decreases by an amount corresponding to a predetermined value or more, the system may be configured to determine that the abnormality is present and transmit a notification to a user.

When the abnormality notification is received, the user may check the power generation system. If there is an abnormality, an appropriate action may be taken.

According to another example embodiment, when determining an abnormality, the abnormality may be determined by comparing product models of a specific power generation system. By performing the comparison between the same product models in addition to the comparison between the power generation systems of the similar regions, the abnormality determination may be performed with increased accuracy. Alternatively, a method of performing the comparison between the same product models without needing to compare the systems of the similar regions is also possible.

According to another example embodiment, a system of redetermining an abnormality using a machine learning model is also be possible. A machine learning unit may perform machine learning based on the power generation amount data and whether the abnormality is present, and redetermine whether the power generation system is abnormal.

Machine learning is a field of artificial intelligence in computer science, which has evolved from the study of pattern recognition and computer learning theory. Also, machine learning is a technology for studying and building a system that learns based on empirical data, performs prediction, and improves its performance, and algorithms therefor. The algorithms of machine learning take a way to build a specific model to derive predictions or decisions based on input data, rather than executing static program instructions defined strictly.

For example, through the machine learning, a machine learning unit may obtain output data for determining whether a power generation system is abnormal or predicting power generation amount data based on factors affecting a power generation amount in solar power generation as input data. That is, based on environmental factors or facility factors affecting the power generation amount as input data, output data associated with the input data may be output.

Specifically, the machine learning unit may perform machine learning using power generation time index data or power generation amount data and an abnormality determination result determined by a processor. The machine learning unit may perform learning by matching the power generation time index or the power generation amount and a corresponding abnormality determination result.

The trained machine learning unit may redetermine whether an abnormality is present using the power generation time index corresponding to the abnormality determination result of the predetermined power generation system determined by the processor. By using the machine learning unit, an effect of reducing a determination error of the processor may be achieved.

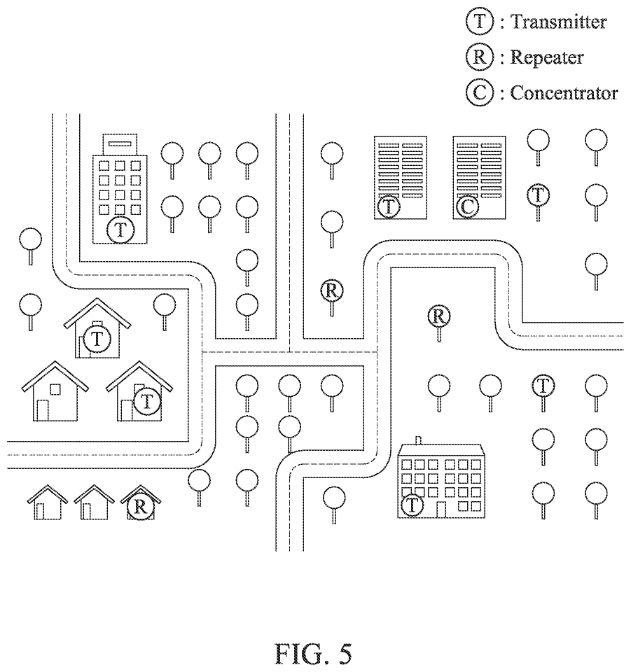

FIG. 5 illustrates an integrated monitoring system monitoring a specific region according to an example embodiment. In the integrated monitoring system, an installation of a power generation system in a specific region may be verified.

FIG. 5 illustrates numerous transmitters and repeaters installed and one concentrator installed.

For example, FIG. 5 illustrates a power generation system installed in a specific region. T denotes a transmitter, R denotes a repeater, and C denotes a concentrator.

The transmitter may correspond to the communicator of FIG. 3. The transmitter may transmit energy data collected for each household to the repeater. The repeater may transmit data received from a plurality of transmitters to a greater distance. That is, there is an effect of extending a transmission distance. The concentrator may serve to collect and gather transmitter data.

According to another example embodiment, instead of the repeater, a low power wide area (LPWA) may be used to perform communication in a wide area at low power. That is, similar to the Internet of things (IOT), the transmitter may be connected directly to the concentrator by performing long-distance communication, not through the repeater.

The transmitter may indicate a place where a power generation system is installed in each house. For example, energy generated by sunlight in each house may transmit corresponding information to the transmitter through the inverter. For example, it may be remote terminal unit (RTU) equipment, but not be limited thereto. The information may be transmitted to a relay line serving as the repeater using an RF model, and then transferred to the concentrator where final data is received, so that all data is collected.

Also, according to another example embodiment, a method of collecting data using an IOT-dedicated network based on a 3G or long-term evolution (LTE) communication scheme may also be possible.

The houses shown on a map of FIG. 5 may be in a village receiving the same weather information. Some errors may occur due to a structural position of a solar module or a shadow interference. However, the power generation time may be mostly measured to be similar or the same to determine that an operation is normal without failure. Therefore, it may be determined that an inspection is required if a power generation time of one house among ten houses is too low or too high. In other words, it may be determined that there is an abnormality.

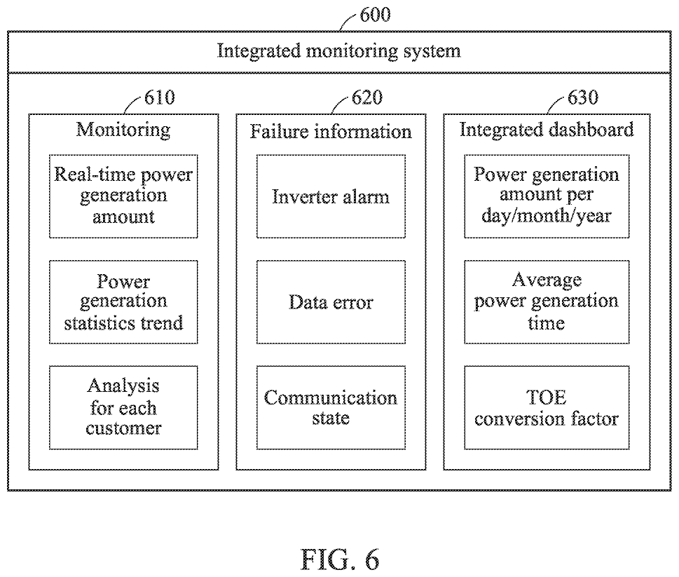

FIG. 6 illustrates a management configuration of an integrated monitoring system according to an example embodiment. An integrated monitoring system 600 according to an example embodiment may include an integrated monitoring-related function 610, a failure information-related function 620, and an integrated dashboard-related function 630.

First, the monitoring-related function 610 of the integrated monitoring system 600 may monitor a real-time power generation amount. For example, how much power a predetermined power generation system is currently producing may be identified.

Also, a power generation statistics trend may be monitored using accumulated data over time. Specifically, a daily power generation amount trend, a weekly power generation amount trend, and a monthly or annual power generation amount trend may be identified. In some cases, a seasonal power generation amount trend or a quarterly power generation amount trend may also be identified.

The integrated monitoring system may perform analysis and monitoring for each customer. In other words, the power generation amount may be identified for individual power generation systems. The real-time power generation amount and the power generation statistics trend may be monitored for each specific region, and the monitoring may also be performed for individual power generation systems.

Next, the failure information-related function 620 of the integrated monitoring system 600 may verify information about an inverter alarm and various sensor's alarms, a data error, and a communication state. In terms of the inverter alarm, an alarm may be generated by an inverter included in the power generation system when a system is not operated properly. When the inverter alarm occurs, a user or operator of the corresponding power generation system may identify that the generation system is abnormal.

For example, if an overcurrent flows in a solar system, the inverter may detect the overcurrent and send an alarm message “overcurrent error.”

For example, the various sensor's alarm may indicate alarms made by various sensors installed in a power generation system such as an alarm by a power plant CCTV tracking system, an alarm occurring in an electricity room of a solar power plant, an alarm for a sensor installed in a solar power plant junction box, and the like, but not be limited thereto.

The data error may correspond to a case in which collected power generation amount data has an error. For example, it may be determined that the data has an error when the power generation amount radically increases or decreases on a specific date.

In addition, in terms of the communication state-related content, a failure (or error) such as a case in which data is not properly collected due to an abnormality of a communication device may be verified.

Also, the integrated dashboard-related function 630 of the integrated monitoring system 600 may display various power generation amounts, an average power generation time, and a ton of oil equivalent (TOE) conversion factor. For a plurality of power generation systems monitored by the integrated monitoring system 600, a total power generation amount per day/month/year may be displayed. In addition, an average power generation time for the plurality of power generation systems may be displayed. In this instance, an average for all the monitored power generation systems may be calculated and displayed. In some cases, an average for some systems, for example, power generation systems in similar regions may be calculated and displayed. Also, the TOE conversion factor may be displayed. The TOE conversion factor may be a result obtained by converting a calorific value of an energy source to a calorific value of petroleum, which is the tone of oil equivalent. As a virtual unit for comparing various energy units, 1 TOE is equivalent to 10 million kilocalories (kcal). As such, the power generation amount of the power generation system may be converted into the TOE conversion factor and displayed on a dashboard.

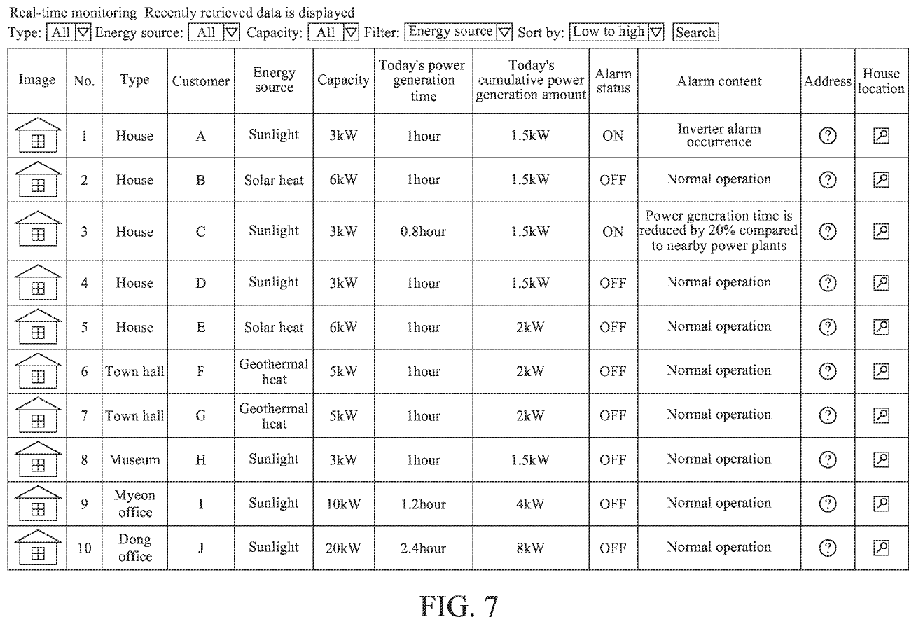

FIG. 7 illustrates a real-time monitoring result of an integrated monitoring system according to an example embodiment.

On a real-time screen of an integrated monitoring system according to an example embodiment, information about a location where a power generation system is installed, an energy source, a capacity, a today's power generation time index, a today's cumulative power generation amount, an alarm status, alarm content, an address, and the like may be displayed. However, it is merely an example, and the displayed information is not limited thereto.

The location where the power generation system is installed may include houses, town halls, museums, buildings, and apartments. The capacity may be a power generation capacity of the corresponding power generation system. In addition, an address where the power generation system is installed may be displayed. Also, an icon that allows a house location to be displayed in a separate window may be displayed.

The today's power generation time index may be a power generation time index expressed by dividing the today's cumulative power generation amount by the power generation capacity of the power generation system. The today's cumulative power generation amount may be a total power generation amount measured up to a real-time monitoring time point of the day. The monitoring system may display an alarm status of each power generation system and may also display content of the corresponding alarm.

A real-time integrated monitoring system may perform sorting based on various criteria and change a sorting result in an ascending order and a descending order. In addition, the real-time integrated monitoring system may perform a function of searching for only a power generation system satisfying a predetermined reference. For example, the real-time integrated monitoring system may search for only a power generation system that exists around a location in a predetermined region and monitor the power generation found. According to another example embodiment, a method of searching for only a house based on a type classification of installation locations is also possible.

The devices described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

While this disclosure includes specific example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example embodiment are to be considered as being applicable to similar features or aspects in other example embodiments. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A method of determining whether an abnormality is present in a renewable energy generation system performed at least temporarily by a computer at predetermined time intervals, the method comprising:
receiving, by a communicator, power generation data from a plurality of power generation systems;
storing, by a storage, the received data;
selecting, by a processor, power generation systems of similar regions from the data collected;
converting, by the processor, power generation amounts of the selected power generation systems of the similar regions into power generation time indices; and
determining, by the processor, whether an abnormality is present in a predetermined power generation system by comparing the power generation time indices.

2. The method of claim 1, wherein each of the power generation indices is an index calculated by dividing a power generation amount obtained for a predetermined period of time in a power generation system by a power generation capacity.

3. The method of claim 2, wherein the selecting of the power generation systems of the similar regions uses at least one of:
selecting a power generation system within a predetermined distance from a certain position;
selecting based on a classification in an administrative area;
selecting based on an installation environment factor; and
selecting based on a climate factor.

4. The method of claim 2, wherein the determining of whether the abnormality is present in the predetermined power generation system comprises:
calculating an average of power generation time indices of power generation systems of similar regions;
determining whether a difference value between a power generation time index of each of the power generation systems and the average of the power generation indices exceeds a predetermined range; and
determining that an abnormality is present when the difference value exceeds the range.

5. The method of claim 2, wherein the determining of whether the abnormality is present in the predetermined power generation system comprises:
comparing the power generation time indices of the power generation systems of the similar regions; and
determining that an abnormality is present when a difference value calculated through the comparing exceeds a predetermined range.

6. The method of claim 2, further comprising:
performing, by a machine learning unit, machine learning based on the data and whether the abnormality is present; and
redetermining, by the machine learning unit, whether an abnormality is present in the power generation system.

7. The method of claim 2, wherein when a predetermined power generation system is determined to be abnormal, the method further comprises:
redetermining whether an abnormality is present in a power generation system using at least one of previous power generation amount data, climate, a sensor defect, and a maintenance history of the predetermined power generation system.

8. A device for determining whether an abnormality is present in a power generation system, the device comprising:
a communicator configured to receive power generation data from at least one power generation system;
a storage configured to store the received data; and
a processor configured to select power generation systems of similar regions from the data collected and determine whether an abnormality is present in a predetermined power generation system by comparing power generation time indices of the power generation systems of similar regions.

9. The device of claim 8, wherein each of the power generation indices is an index calculated by dividing a power generation amount obtained for a predetermined period of time in a power generation system by a power generation capacity.

10. The device of claim 9, wherein the processor is configured to select the power generation systems of the similar regions using at least one of a method of selecting a power generation system within a predetermined distance from a certain position, a method of selecting based on a classification in an administrative area, a method of selecting based on an installation environment factor, and a method of selecting based on a climate factor.

11. The device of claim 9, wherein the processor is configured to calculate an average of power generation time indices of power generation systems of similar regions, determine whether a difference value between a power generation time index of each of the power generation systems and the average of the power generation indices exceeds a predetermined range, and when the difference value exceeds the range, determine that an abnormality is present.

12. The device of claim 9, wherein the processor is configured to compare the power generation time indices of the power generation systems of the similar regions, calculate a difference value through the comparing, and when a difference value calculated through the comparing exceeds a predetermined range, determine that an abnormality is present.

13. The device of claim 9, further comprising:
a machine learning unit configured to perform machine learning based on the data and whether the abnormality is present and redetermine whether an abnormality is present in the power generation system.

14. The device of claim 9, wherein when a predetermined power generation system is determined to be abnormal, whether an abnormality is present in a power generation system is redetermined using at least one of previous power generation amount data, climate, a sensor defect, and a maintenance history of the predetermined power generation system.

15. A computer-readable recording medium comprising a program for performing the method of claim 1.
